(19) United States
(12) Patent Application Publication
(10) Pub. No.: US 2008/0035840 A1
(43) Pub. Date: Feb. 14, 2008

(54) Process and apparatus for isotope determination of condensed phase samples

(75) Inventors: Michael May, Dayton, OH (US); Michael Gray, Dayton, OH (US)

Correspondence Address: SENNIGER POWERS (SGM), ONE METROPOLITAN SQUARE, 16TH FLOOR, ST. LOUIS, MO, 63102, US

(73) Assignee: SIGMA-ALDRICH CO., St. Louis, MO (US)

(21) Appl. No.: 11/756,865

(22) Filed: Jun. 1, 2007

Related U.S. Application Data
(63) Continuation of application No. 11/423,317, filed on Jun. 9, 2006.

(51) Int. Cl. B01D 59/44

(52) U.S. Cl. 250/282

(57) ABSTRACT

A process for isolating a carbon fraction representative of the carbon contained in a specimen of a condensed phase carbonaceous composition. The carbon fraction is isolated in the form of a carbon oxide gas that may be introduced into a mass spectrometer for determining the proportion of the carbon isotope content of the composition that is constituted by ¹³C. A novel apparatus is provided which is useful in conducting the process.

### FIELD OF THE INVENTION

This invention relates to the field of isotope analysis, and more particularly to a useful process and apparatus for determining the isotopic composition of a condensed phase composition, and more particularly the ¹⁵N-isotopic content of a nitrogenous composition or the ¹³C-isotopic content of a carbonaceous composition.

As described by Metges and Petzke, “The Use of GC-C-IRMS for the Analysis of Stable Isotope Enrichment in Nitrogenous Compounds,” Chapter 7, Methods of Amino Acid and Protein Metabolism, A. E. El-Khoury, Ed., CRC Press, Boca Raton (1999), the relative natural abundance of the main stable isotopes in bioelements (²H, ¹³C, ¹⁵N, ¹⁸O) varies within subtle limits due to isotope fractionation processes in nature. Isotope labeling is also widely used in various industrial applications for tracing flow paths, determining flow volumes and evaluating chemical and biological reactions. In biological and medical research applications, isotope labeling is used for evaluating the distribution and metabolic or pharmacokinetic fate of nutrients, pharmaceuticals, etc.

Various methods are known for determining the ¹³C and/or ¹⁵N content of organic compounds, including proteins. Typically, proteins are subjected to wet digestion, e.g., in hydrochloric acid, by which they are degraded into mixtures of their constituent amino acids, after which the amino acids are derivatized and subjected to analysis. Prior to isotope analysis, the amino acid derivatives may be separated by gas chromatography. The individual amino acid derivatives are then successively subjected to vapor phase combustion in a dynamic flow process wherein the combustion gas product is treated to isolate a CO₂ fraction, which is introduced into a mass spectrometer for ¹³C analysis, and/or an N₂ fraction, which is introduced into a mass spectrometer for ¹⁵N analysis. In some systems, the combustion product gas is subjected to gas chromatography to separate the desired analyte, e.g., CO₂ or N₂, from other gases prior to introduction of the analyte gas into the mass spectrometer. These dynamic systems often use specialized isotope ratio mass spectrometers for determination of isotope content. Other relatively volatile organic compounds can also be separated by GC and subjected to isotopic analysis in the same manner as the amino acids obtained from digestion of proteins.

In other methods, amino acids obtained by protein digestion, or other nitrogenous organic compounds have been analyzed for isotopic content using nuclear magnetic resonance (NMR). For many applications, especially intractable biosynthesized proteins and peptides, NMR has not provided satisfactory results. This is related to issues such as hydrogen exchange, NMR spectral complexity, and ¹⁵N-signal sensitivity.

Metges and Petzke, supra describe a system employing isotope ratio mass spectrometry for determining ¹³C, ¹⁵N and/or ¹⁸O content of a composition such as a mixture of amino acids. Where the composition of interest is a protein or peptide, it would typically be subjected to wet acid digestion to provide the amino acid components used in the analysis. In the reference system, each of the amino acids may be separately analyzed with respect to C or N isotope content by conversion to a gas comprising CO₂ and/or N₂, isolation of the gas component that incorporates the isotope to be determined, and analysis of the isolated gas stream using an isotope ratio mass spectrometer. Preparatory to combustion, the amino acid derivatives are separated in a chromatographic column and each derivative of interest is then oxidized in the gas phase in an oxidation oven which comprises an alumina tube filled with various combinations of nichrome or copper oxide, nickel oxide and platinum wires. A mixture comprising CO₂, H₂O, N₂ and NOₓ flows from the oxidation oven to a reduction oven where the gas is contacted with elemental copper for reduction of NOₓ and scavenging of surplus oxygen. Water vapor is removed by passing the gas through a water-permeable membrane or cold trap. Where the object is to analyze the nitrogen content of the sample, the product gas may be passed through a trap maintained near −196° C. for removal of CO₂. From the exit of the chromatographic column to inlet of the mass spectrometer, the gas phase passes through the system substantially in plug flow. Metal oxide oxidants can be periodically replenished by flowing dioxygen through the oxidation oven.

Matthews and Hayes, “Isotope-Ratio-Monitoring Gas Chromatography-Mass Spectrometry,” Analytical Chemistry, Vol. 50, No. 11, pp. 1485 to 1473 (September 1978) also describe a system wherein a sample is separated by gas chromatography and quantitatively reacted in the gas phase in a catalytic furnace. As described in FIG. 2 thereof, the combustion oven is serially connected to water and carbon dioxide traps and the traps are connected to the GCMS separator. CuO is used as oxidant, supplemented by O₂. A pyrex tube downstream of the furnace is filled with magnesium perchlorate to trap H₂O. A liquid N₂ cooled trap downstream of the magnesium perchlorate water trap serves to remove CO₂ before the gas phase enters the mass spectrometer. Nitrogen isotope analysis is specifically described.

Preston and Owens, “Interfacing an Automatic Elemental Analyzer with an Isotope Ratio Mass Spectrometer; the Potential for Fully Automated Total Nitrogen and Nitrogen-15 Analysis,” Analyst, August 1983, Vol. 108, pp. 971-977 describe a system wherein combustion of a specimen to be analyzed is conducted per the Dumas method in an automatic nitrogen analyzer comprising an elemental gas chromatograph. Combustion gases are separated by gas chromatography and flow serially to a mass spectrometer.

Other systems for isotope ratio analysis are described in Hall U.S. Pat. No. 4,866,270, Brand U.S. Pat. No. 5,424,539, and Ellis et al. U.S. Pat. No. 5,783,741.

Gustin et al., “A Simple, Rapid Automatic Micro-Dumas Apparatus for Nitrogen Determination,” Microchemical J., Vol. IV, pp. 43-54 (1960) describe an apparatus (FIG. 2 of the reference) for Dumas combustion comprising a first unit, consisting of a temporary packing of CuO wherein organic compounds are pyrolyzed quickly at 850° C., and a second unit consisting of Cu—CuO at 400° C. to 500° C., in the presence of which CO₂ does not dissociate and any CO present may be oxidized to CO₂. CO₂ is absorbed in caustic solution. Samples are introduced into the reaction tube in Pt or alumina disposable boats.

A need remains for a process and apparatus that are useful and effective for the determination of the average ¹⁵N and/or ¹³C-content of condensed phase specimens, especially intractable biosynthesized analytes such as peptides, proteins, or cellular material, as well as chemically synthesized carbonaceous and/or nitrogenous analytes such as nitroanilines, amino acids, polyaromatic hydrocarbons, starches, polymers, elemental carbon, etc. Such solid specimens can contain significant quantities of bound solvent. For purposes of effective and accurate analysis, it may be necessary or desirable to remove the bound solvents, especially where they are carbonaceous and/or nitrogenous reagents such as acetonitrile, pyridine, alcohols, esters, ketones or ammonium hydroxide, in which the ¹³C/¹²C ratio or the ¹⁵N/¹⁴N ratio may differ significantly from the corresponding ratio in the actual analyte.

Determination of ¹⁵N vs. ¹⁴N or ¹³C vs. ¹²C by mass spectrometry is often complicated by the fact that CO has the same nominal mass as ¹⁴N₂, i.e., a molecular weight of 28, and ¹³CO has a molecular weight 29. By comparison, dinitrogen species relatively enriched in ¹⁵N have molecular weights of 30 (¹⁵N₂) or 29 (¹⁵N¹⁴N). Thus, it is desirable to eliminate CO from either a CO₂ sample or an N₂ sample before it is introduced into the spectrometer.

### SUMMARY OF THE INVENTION

Among the several objects of certain or various preferred embodiments of the present invention may be noted the provision of a process for the determination of the proportion of the average carbon isotope content of a composition that is constituted by ¹³C or average nitrogen isotope content that is constituted by ¹⁵N; the provision of a process which may be practiced to determine such proportion of ¹³C or ¹⁵N in a condensed phase sample; the provision of a process to determine such proportion of ¹³C or ¹⁵N in a solid phase sample; the provision of such a process in which bound solvent may be controllably removed from a solid specimen before ¹⁵N or ¹³C-analysis thereof; the provision of such a process which may be practiced remotely (off-line) from a mass spectrometer to produce a CO₂ or N₂ gas combustion product that can be delivered to the mass spectrometer; the provision of such a process which can be conducted without the need for chromatographic separation of gaseous combustion products; the provision of such a process by which the average ¹⁵N or ¹³C-content of a carbonaceous or nitrogenous specimen, especially a condensed phase specimen such as a peptide, protein, a cell culture or other cellular specimen, e.g., algal cells, or a tissue specimen can be determined without the necessity of, and preferably without, wet digestion and/or chromatographic separation of constituent amino acids; the provision of a process for determining the average ¹³C-content of organic compositions such as polyaromatic hydrocarbons and oxygenated or sulfur-bearing hydrocarbon polymers such as poly(acrylics), poly(esters), poly(sulfones), etc.; the provision of such a process which may be conducted on a batch basis; the provision of such a process which can be conducted in a free-convectively mixed process chamber; and the provision of specialized apparatus useful in conducting the process.

The present invention provides a process and apparatus that are conveniently and advantageously used to determine the proportion of the average carbon content of a composition that is constituted by ¹³C or the average nitrogen content that is constituted by ¹⁵N. The process and apparatus are advantageously adapted for the determination of the ¹³C or ¹⁵N content of a condensed phase composition, especially a composition that is in the solid state under ambient conditions. The apparatus may also be useful for determining the proportions of isotopes of other elements such as, e.g., sulfur or phosphorus in a condensed phase sample.

In a preferred embodiment, therefore, the present invention is directed to a process for isolating a carbon or nitrogen fraction representative of the carbon or nitrogen contained in a specimen of a condensed phase carbonaceous and/or nitrogenous composition. The representative fraction is isolated in the form of a carbon oxide or dinitrogen gas that may be introduced into a gas analyzer (for example a mass spectrometer) for determining the proportion of the carbon or nitrogen isotope content of the composition that is constituted by ¹³C or ¹⁵N. In accordance with the process, a specimen comprising the condensed phase composition or alternatively a vapor generated from the condensed phase composition is contacted with a primary oxidant in a combustion region within a zone for generation and isolation of carbon oxide(s) or dinitrogen derived from carbon or nitrogen contained in the specimen. The specimen is reacted in the combustion region to generate a combustion product gas In the case of ¹⁵N determination, the combustion product gas may comprise, e.g., dinitrogen, carbon oxides and water. In the case of ¹³C determination, the combustion product gas may comprise, e.g., CO2, CO and water, or CO₂, CO, N₂ and water.

Optionally, water vapor can be removed from the combustion product gas in a dehydration region spaced from the combustion region within the generation and isolation zone. For example, the dehydration region may comprise a sorption region wherein combustion product gas may be contacted with a sorbent effective for sorption of a gas component selected from the group consisting of carbon dioxide, carbon monoxide, water and combinations thereof. The gas component is sorbed from the gas phase to the sorbent in the sorption region. With regard to ¹³C-determination, a sorbent may optionally be used to remove water, producing a carbon gas fraction in which the water vapor content is not more than about 5 volume %, basis CO₂. With regard to ¹⁵N-determination, it is preferable to utilize a sorbent that removes both water and CO₂, producing a nitrogen gas fraction in which the sum of the water vapor content and the CO₂ content is not more than about 5 volume %, basis N₂.

The invention is further directed to a process for isolating a carbon or nitrogen fraction as defined above wherein a carbonaceous or nitrogenous condensed phase specimen is contacted with a primary oxidant in a combustion region within a zone for generation and isolation of carbon oxide(s) or dinitrogen derived from carbon or nitrogen contained in the specimen, the gas phase being subject to convective mixing within the zone. In the determination of ¹³C content, the composition is reacted in the combustion region to generate a combustion product gas comprising CO₂ and water. Optionally, the combustion gas may be additionally contacted with a supplemental reaction agent effective for conversion of carbon monoxide to carbon dioxide, thereby providing a carbon oxide gas fraction of which the carbon monoxide content comprises not more than about 10 volume %, preferably not more than about 10 volume %, preferably not more than about 5 volume %, basis CO₂.

In the determination of ¹⁵N content of a nitrogenous specimen, the composition is reacted in the combustion region to generate a combustion product gas comprising N₂, CO₂ and water. In a sorption region within the generation and isolation zone, the combustion gas may be contacted with a sorbent effective for sorption of a gas component of the combustion gas selected from the group consisting of CO₂, water and combinations thereof. The gas component is sorbed from the gas phase to the sorbent in the sorption region, thereby providing a nitrogen gas fraction of which the sum of the water vapor content and the CO₂ content preferably comprises not more than about 5 volume %, basis N₂.

The invention is further directed to a process for isolating a carbon or nitrogen fraction as defined above wherein the specimen is contacted with a primary oxidant in a combustion region within a zone for generation and isolation of carbon oxide(s) or N₂ derived respectively from carbon or nitrogen contained in the specimen, and the composition is reacted in the combustion region to generate a combustion product gas. To perform ¹³C-determination, the specimen may be contacted with a primary oxidant plus a supplemental reactant in a combustion region so that the product gas comprises carbon dioxide and water. The process/apparatus for ¹³C-determination can provide a carbon oxide gas fraction of which the sum of the dihydrogen content, carbon monoxide content, and nitrogen oxides content comprises not more than about 15 volume %, basis CO₂. To perform ¹⁵N-determination, the specimen may be contacted with a primary oxidant plus a supplemental reactant (for conversion of CO to CO₂) in a combustion region, and the gas-phase contacted with a sorbent in a sorption region so that the product gas substantially comprises dinitrogen. This sorbent is effective for sorption of a gas component selected from the group consisting of CO₂, water, and combinations thereof, and thereby the selected components can be sorbed from the gas phase to the sorbent in a sorption region. The process/apparatus for ¹⁵N-determination can provide a nitrogen gas fraction of which the sum of the water content and the CO₂ content comprises not more than about 5 volume %, basis N₂. For both types of isotope determination, a favorable temperature gradient may be set up throughout the generation and isolation zone causing the combustion product gas to become substantially mixed.

The invention is further directed to an apparatus for isolating a fraction representative of the isotope distribution of an element contained in a specimen of a condensed phase composition, the fraction being isolated in the form of a gas that may be introduced into a gas analyzer for determining the proportion of a specific isotope of an element contained in a given composition, and/or the proportion of a particular element that is constituted by a specific isotope thereof. The apparatus comprises a tubular process vessel having a primary gas port for influx of a primary oxidant gas and/or efflux of gas containing the aforesaid element that is generated by combustion within the vessel, and a first station within the vessel for holding a condensed phase specimen. Preferably the tubular process vessel embodies a fused-glass pipe that is composed of several tubular segments and an integral threaded socket at each terminus. The first station is spaced from the process vessel ports with respect to the vessel longitudinal axis. The apparatus further comprises a furnace for heating a specimen in the presence of said primary oxidant to effect combustion of said specimen and the generation of a combustion product gas comprising a component of said element. Preferably, the furnace is capable of establishing and sustaining an axial temperature gradient about the vessel longitudinal axis that is favorable for process operations. For example, the tubular process vessel may be spatially arranged with the furnace to establish such axial thermal gradient.

In order to perform ¹⁵N-isotopic determination, the apparatus further comprises a second station within the vessel. The second station is spaced from both the first station and the process vessel primary port with respect to the longitudinal axis of the vessel. The second station is adapted to receive a sorbent, the sorbent being effective for sorption of a component of a gas phase in contact with the sorbent, the sorbent being effective for sorption of a gas component that does not contain the element to be isotopically determined. Optionally, the apparatus may also contain a second station for use in connection with the determination of ¹³C. In the latter instance, the second station may contain, e.g., a sorbent for water and/or CO, or a supplemental reaction agent for conversion of CO to CO₂.

The invention is further directed to a process for isolating a carbon oxide or nitrogen fraction representative of the carbon and/or nitrogen contained in a specimen of a condensed phase composition, the fraction being isolated in the form of a carbon oxide or N₂ gas that may be introduced into a gas analyzer for determining the proportion of the carbon isotope content of the composition that is constituted by ¹³C, or the proportion of nitrogen isotope content of the composition that is constituted by ¹⁵N. A specimen comprising the condensed phase composition or alternatively a vapor generated from the condensed phase composition is contacted with a primary oxidant in a convectively mixed combustion region within a zone for generation and isolation of carbon oxide(s) or N₂ derived from carbon or nitrogen contained in the specimen. The specimen is reacted in the combustion region to generate a combustion product gas comprising carbon dioxide or dinitrogen.

As needed for a particular determination, the combustion gas can be dehydrated, e.g., by contact with a sorbent in a sorption region spaced from the combustion region within the generation and isolation zone, thereby removing water vapor from the combustion gas and providing a carbon oxide or nitrogen gas fraction in which the water vapor content comprises not more than about 5 volume %, basis CO₂. Alternatively, the water content may be reduced to these levels by condensation in a cold trap in a dehydration region spaced from the combustion region in the generation and isolation zone. In isolation of an N₂ fraction, water vapor may be sorbed from the gas phase to the sorbent in the sorption region, thereby providing a nitrogen gas fraction of which the sum of the water vapor content and the carbon dioxide content comprises not more than about 5 volume %, basis N₂.

The invention is further directed to a process for isolating a carbon fraction representative of the carbon contained in a specimen of a condensed phase carbonaceous composition, the fraction being isolated in the form of a carbon oxide gas that may be introduced into a gas analyzer for determining the carbon isotope proportion of said composition that is constituted by ¹³C. The process comprises contacting a condensed phase specimen of the carbonaceous composition with a primary oxidant in a combustion region within a zone for generation and isolation of a carbon oxide derived from carbon contained in the specimen. The specimen is reacted in the combustion region to generate a combustion product gas comprising carbon oxides and water; and the ¹³C-isotope content of a carbon oxide gas fraction produced in the generation and isolation zone, or a sample thereof, is determined. The carbon oxide gas fraction comprises the combustion product gas or a gas fraction obtained by modifying the composition of the combustion product gas.

The inventions is further directed to a process for isolating a carbon fraction representative of the carbon contained in a specimen of a condensed phase carbonaceous composition selected from the group consisting of algal cells, peptides, proteins, protein extracts, starch, nitroanilines, polyaromatic hydrocarbons, starches, polymers, and elemental carbon, the fraction being isolated in the form of a carbon oxide gas that may be introduced into a gas analyzer for determining the carbon isotope proportion of the composition that is constituted by ¹³C. The process comprises contacting the specimen in a condensed or vaporized state with a primary oxidant in a combustion region within a zone for generation and isolation of a carbon oxide derived from carbon contained in the specimen. The specimen is reacted in the combustion region to generate a combustion product gas comprising carbon oxides and water; and the ¹³C-isotope content of a carbon oxide gas fraction produced in the generation and isolation zone, or a sample thereof, is determined. The carbon oxide gas fraction comprises the combustion product gas or a gas fraction obtained by modifying the composition of the combustion product gas.

Other objects and features will be in part apparent and in part pointed out hereinafter.

### BRIEF DESCRIPTION OF THE DRAWINGS

FIG. 1 is a schematic block diagram illustrating a preferred embodiment of the process of the invention;

FIG. 2 is an exploded view in section of an apparatus comprising a tubular process vessel plus auxiliaries useful in carrying out the process of the invention, which includes both a combustion station for a condensed phase specimen and, spaced from the combustion station, a sorption station for sorption of water vapor and/or CO₂ generated in the combustion;

FIG. 3 is a schematic illustration of an apparatus similar to that of FIG. 2 but containing a third station for reduction of NOₓ, the third station being spaced from both the combustion station and the sorption station within the process vessel (one port of the apparatus may be sealably attached to a specimen containment module as illustrated in FIG. 6);

FIG. 4 is an exploded perspective view in section of an assembly comprising a gas manifold for use in connection with the process vessel of FIG. 2 or 3 in carrying out the process of the invention;

FIG. 5 is a typical longitudinal (axial) temperature profile in the tubular process vessel of FIG. 1 during combustion of a specimen to generate a combustion product gas substantially comprising CO₂ or N₂; and

FIG. 6 is an exploded plan view in section of a specimen containment module which is adapted for attachment to the tubular process vessel as illustrated in either FIG. 2 or FIG. 3.

Corresponding reference characters indicate corresponding parts throughout the drawings.

### DETAILED DESCRIPTION OF THE INVENTION

In accordance with the present invention, an advantageous process and apparatus are provided by which a specimen of a condensed phase composition may be reacted to generate gases suitable for mass spectrometric determination of the proportion of the composition carbon content that is constituted by ¹³C, the proportion of the composition nitrogen content that is constituted by ¹⁵N, or the proportions of other elements that may be constituted of particular isotopes, such as, e.g., ³³P or ³⁴S. Preferably a specimen of the composition is reacted using dry combustion, i.e., without need for preliminary acid digestion of a composition such as a biosynthesized protein or peptide to break it down into its constituent amino acids. By directly combusting a specimen of an unknown composition, any isotopic contamination or adulteration that might otherwise arise in the digestion process may be avoided. Direct combustion also avoids the corrosive conditions typically incurred in wet digestion with hydrochloric acid. The process is relatively practical and straightforward, and the apparatus simple, economical and robust. Moreover, the system is amenable to the determination of ¹³C or ¹⁵N content by injecting isolated CO₂ or N₂ into a general-purpose mass spectrometer rather than a specialized isotope ratio mass spectrometer.

The process can be conducted in a batch mode to produce a convectively mixed carbon oxide or N₂ gas fraction that can be injected into the mass spectrometer at the convenience of the operator. Unlike dynamic flow systems of the prior art, the operation of the process and apparatus of the invention does not require critical timing of the introduction of the gas stream into the mass spectrometer, or critical control of the interval between the combustion step and the gas analysis. This obviates the need for sophisticated, typically computer driven, control systems that are necessary to identify and divert an N₂, CO₂ or other isotopically representative fraction to the spectrometer. Moreover, the apparatus can be cleaned and reused a large number of times, e.g., ordinarily at least 10, more typically at least 50, and often at least 100 times before it must be discarded or overhauled.

The process and apparatus are particularly adapted for the determination of ¹⁵N/¹⁴N ratios in condensed phase nitrogenous compositions or ¹³C/¹²C ratios in condensed phase carbonaceous compositions, e.g., solid-phase organic compositions, and/or compositions of relatively low vapor pressure. A prominent application is for analysis of the ¹³C or ¹⁵N content of proteins, peptides, mixtures of proteins and peptides, lyophilized biological cells, algal cells, or a tissue specimen, but the process is also well adapted for the determination of ¹³C or ¹⁵N in chemically synthesized compositions such as solid asphalts, solid tars, polyaromatic materials, oxygenated or sulfur-bearing hydrocarbon polymers, nitroanilines, nitrophenols, phthalimides, phenylene diamines and/or other nitrogenous aromatic compounds. ¹⁵N-bearing and/or ¹³C-bearing amino acids are also subject to analysis according to the process of the invention. More generally, the process might be adapted for ¹³C or ¹⁵N-determination of solid-phase compositions that include amines, amides, nitro-group chemicals, nitrogenous heterocycles, enzymes, purines, pyrimidines, polyaromatic hydrocarbons, polyacrylics, polyethers, polyesters, polysulfones and select drugs. In various preferred applications, the composition subject to analysis is substantially in the solid phase at 100° C. and/or has a vapor pressure less than about 10 mm Hg, preferably less than about 1 mm Hg, at 100° C. and/or has an atmospheric boiling point greater than about 200° C.

Biosynthesized proteins, biosynthesized peptides, algal lyophilized cells, other cellular specimens, tissue culture or other tissue specimen and other carbonaceous or nitrogenous materials or specimens are often solvated with residual solvent used in their preparation. Although they are also commonly lyophilized after synthesis, lyophilization is generally effective only for removal of free solvent, not for removing bound solvent that may be bonded to the carbonaceous and/or nitrogenous product via hydrogen bonding or the like, and/or present as inclusions embedded within the solid mass. In various preferred embodiments of the process of the invention, a specimen of the composition is controllably desolvated within the process vessel prior to combustion thereof.

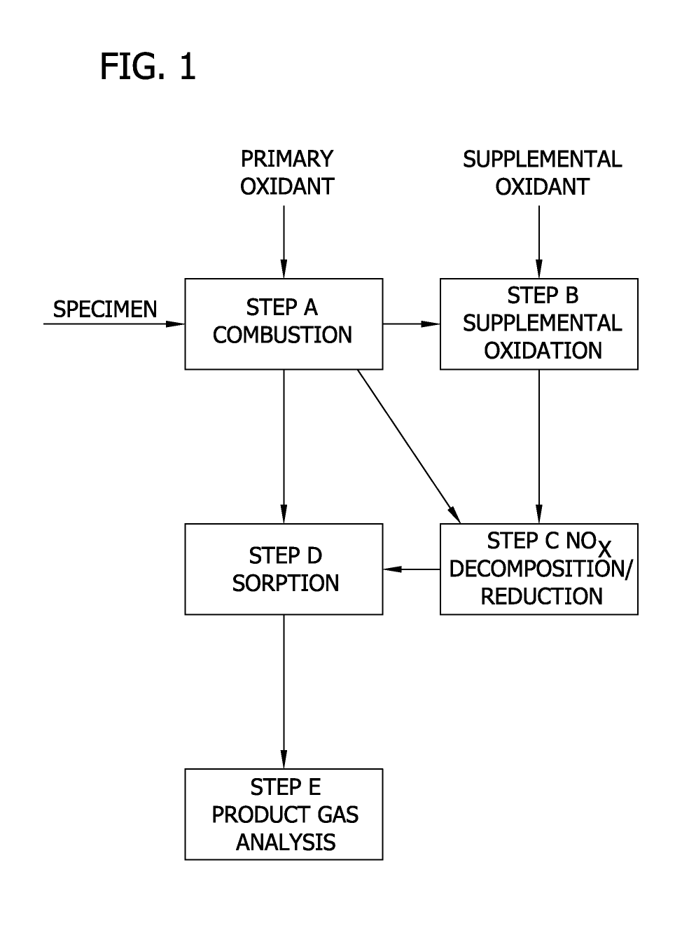

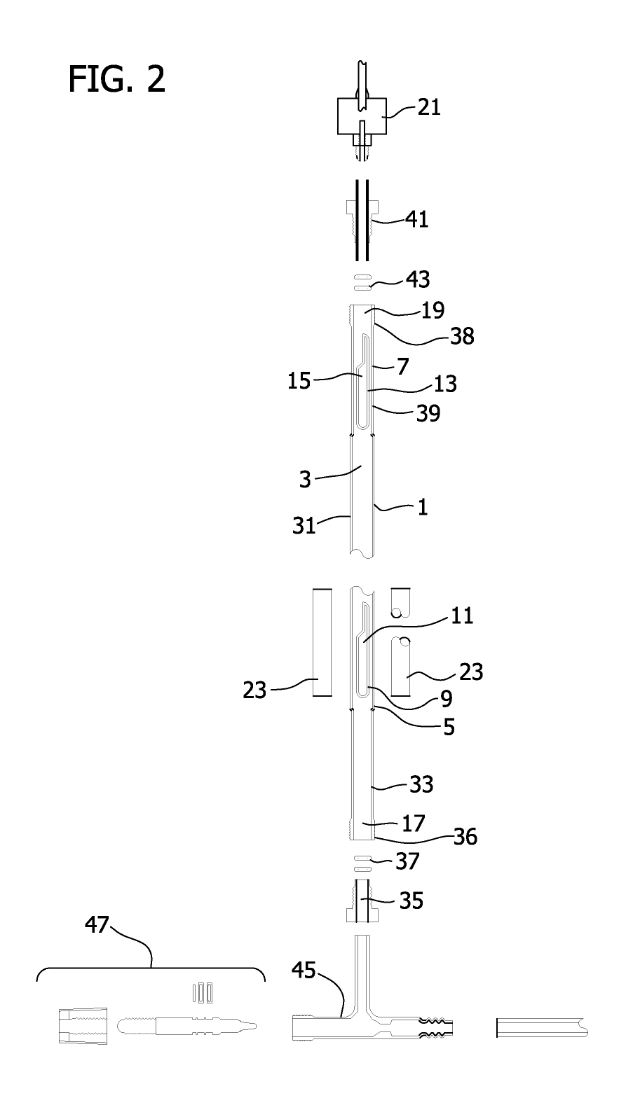

FIG. 1 schematically illustrates a preferred embodiment of the process invention. Although FIG. 1 is depicted as a flowsheet, the process is preferably conducted in a batch mode in which the various steps of the process are carried out in a single carbon oxide or nitrogen generation and isolation zone, e.g., a space within a single compartment or chamber in a process vessel of the type illustrated in FIG. 2. Where the specimen is solvated, especially where it is solvated with a carbonaceous or nitrogenous reagent such as benzene, toluene, xylene, a lower alcohol, an ester (e.g., ethyl acetate), a ketone (e.g., MEK, MIBK or MIAK), an ether (e.g., ethyl ether), acetonitrile, pyridine, dimethylformamide, triethylamine, ethylenediamine, or ammonium hydroxide, the specimen is preferably first desolvated (step A) either under reduced pressure, by heating, or by a combination of reduced pressure and heating. A primary oxidant, preferably dioxygen, is then introduced into the carbon oxide or nitrogen generation and isolation zone and brought into contact with the specimen in a combustion region of the generation and contact zone (step B). Combustion of the specimen generates a combustion product gas substantially comprising CO₂ and water vapor, or CO₂, water vapor and N₂. Combustion need not be complete, so long as sufficient CO₂ or N₂ is generated for purposes of isotopic analysis. However, analysis for ¹⁵N is facilitated by removal of CO, preferably by conversion to CO₂. Operation of a mass spectrometer is also facilitated by limiting the proportion of gas components that are extraneous to the isotopes of interest. Thus, in the case of ¹⁵N-determination, it is desirable to remove carbon oxides and water vapor that are present in the combustion product gas. Carbon oxides are effectively removed by converting CO to CO₂ and sorbing the CO₂ to a sorbent in a sorption region spaced from the combustion region within the N₂ generation and isolation zone. In the sorption region the combustion product gas is contacted with a sorbent (step D) for sorption of water vapor and CO₂ from the gas phase. For certain ¹³C-determinations, it may be desirable to further utilize a supplemental reactant in the combustion region (or another region) to convert CO to CO₂ during combustion, thereby increasing the partial pressure of CO₂ in the combustion product gas.

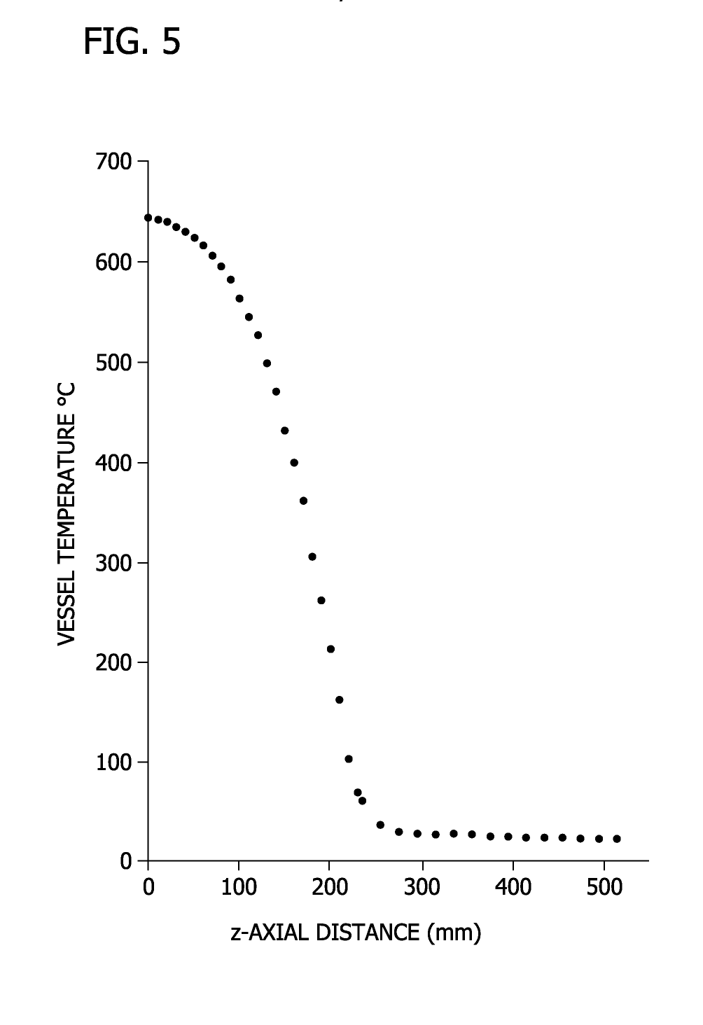

As illustrated in FIG. 5, a substantial temperature gradient prevails along the longitudinal axis of the generation and isolation zone during combustion of the specimen, so that the sorption region is ordinarily at a temperature well below the combustion temperature. Contact of the combustion product gas with a sorbent at such lower temperature enables sorption of water vapor and/or CO₂ from the gas phase, thus yielding a carbon oxide or nitrogen gas fraction that may be analyzed for ¹³C/¹²C or ¹⁵N/¹⁴N ratio.

In many if not most instances, the combustion product gas may also at least nascently contain CO and NOₓ. Especially where solid specimens are combusted, carbon contained in specimen compounds may not be fully oxidized, especially at the modest ratios of dioxygen to specimen described below. Moreover, under the prevailing combustion conditions, CO₂ tends to partially dissociate. In various preferred embodiments, as described below, a supplemental reaction agent is provided to oxidize CO to CO₂. The supplemental reaction agent may be provided within the combustion region where oxidation of CO to CO₂ proceeds (step B). As described below, contamination with NOₓ has generally proven not to be a major problem in conducting the process using the apparatus of the invention. It is believed that during combustion NOₓ may be reduced (step C) by reaction with transient NHₓ, or by reaction with transient CHₓ, or by reaction with carbon char produced by incomplete combustion of the specimen. Optionally however, the gas phase may be contacted with a reductant for NOₓ within the generation and isolation zone, either inside or outside the combustion region. Where a reductant for NOₓ is used, a discrete reduction region may be preferably positioned within the generation and isolation zone at a location where a temperature effective, more preferably optimal, for NOₓ reduction may prevail during combustion, i.e., a location along the temperature profile of FIG. 5 that is optimal for the purpose. A preferred location may be either within the combustion region or alternatively in a discrete reduction region spaced from both the sorption/dehydration and combustion regions within the zone. As needed, the reductant may be longitudinally positioned in the combustion region or alternatively in a discrete reduction region spaced from both sorption and combustion regions. Those skilled in the art can readily determine an optimal location for the reductant based on the typical longitudinal temperature profile during combustion. Preferably a relatively small quantity of reductant is used, to minimize or avoid generation of hydrocarbons or hydrogen gas. For example, the quantity of reductant may be equivalent to between 0% and about 35%, more typically between about 1% and about 15%, of the carbon content of the specimen. Any convenient reductant may be used for reduction of NOₓ, e.g., iron powder, copper powder, nickel powder, or platinum/rhodium on alumina.

Over the course of a combustion and sorption cycle, the composition of the combustion gas approaches a steady-state kinetic condition in which chemical reactions reach equilibrium, phase equilibrium is established with sorbent(s), and/or condensate at a cold trap, contained within the zone, and concentration gradients have been eliminated by axial (and radial) convective mixing. For the case of ¹⁵N-determination, both water vapor and CO₂ are preferably depleted from the gas-phase.

Free-convective mixing of the gas phase within the space defining the generation and isolation zone yields a carbon oxide or nitrogen gas fraction of substantially steady-state and uniform composition within the generation and isolation zone, typically within the single chamber of the process vessel of FIG. 2, that is preferably closed during combustion against the introduction of any gas that is not subject to removal by dehydration or sorption in the dehydration or sorption region of the zone. At the operator's convenience, the process vessel may be transported to the location of an off-line mass spectrometer or other gas analyzer and the combustion product gas contained in the vessel, or more typically a sample thereof, may be injected into the gas inlet port of the spectrometer for analysis of the relative proportions of ¹³C and ¹²C in a carbon oxides gas fraction, or of ¹⁵N and ¹⁴N in a nitrogen gas fraction, which are respectively reflective of the relative proportions of carbon or nitrogen isotopes in the specimen subjected to combustion. Because the carbon oxide or nitrogen gas fraction is generated on a batch basis, precise gas transfer timing between process vessel and mass spectrometer is not critical. The spectrometer into which the sample is injected may comprise a general-purpose quadrupole. A specialized isotope ratio mass spectrometer is not required to perform the process.

FIG. 2 illustrates an apparatus of the invention which comprises a tubular process vessel 1, the interior of which defines a carbon oxide or nitrogen generation and isolation zone 3 comprising discrete combustion and sorption regions 5 and 7, respectively. If the apparatus is used for isotopic determination of an element other than carbon or nitrogen, the apparatus may function to isolate a compound of such other element, e.g., SO₂, PCl₃, O₂, H₂, etc. Within combustion region 5 is a combustion station 9 comprising a quartz boat 11 holding a specimen of the composition to be analyzed. Quartz boat 11 may also contain a supplemental reaction agent for oxidizing CO generated in the combustion to CO₂ and also an optional reductant. Within sorption region 7 is a sorption station 13 comprising another quartz boat 15 holding a sorbent for water vapor. In an apparatus adapted for determination of ¹³C, the sorbent is typically selected to remove water vapor only, or water vapor plus carbon monoxide. As indicated, a cold trap or other heat exchange device may be substituted for the sorbent station in an apparatus primarily adapted for ¹⁵N-determination. At or near one end of the tubular process vessel, typically on the side of the combustion region opposite from the sorption or other dehydration region, is a gas flow port 17 comprising an internally threaded socket 36 (integrally fused with vessel 1) for inflow of a primary oxidant gas and outflow of the carbon oxide or nitrogen gas fraction produced by combustion of the specimen and removal as appropriate of water and/or CO₂. As described below, the vessel may also be evacuated and/or volatile contaminants such as a bound solvent removed via port 17. At or near the other end of process vessel 1 is a secondary access port 19 comprising an internally threaded socket 38 that can optionally and alternatively be sealably plugged or sealably connected to a pressure transducer 21. In the embodiment of FIG. 2, both combustion station 9 and sorption station 13 are located between socket 36 and socket 38 with respect to the longitudinal axis of the process vessel 1. Thus, the generation and isolation zone is formed within a single chamber which may be closed during combustion and optional sorption/dehydration against the introduction of any gas that is not subject to removal by sorption or dehydration in a region adapted for such removal, and/or against the introduction of any gas that is not subject to isotopic determination. Typically, the generation and isolation zone is also closed against removal of gas during the combustion phase of the operation.

The combustion region 5 of generation and isolation zone 3 within tubular process vessel 1 is surrounded by a heat source, e.g., an electrical resistance furnace 23 such as a Carbolite MTF 12/38/9400 furnace, which is effective for heating the specimen in boat 11 to its reactive temperature. The furnace is adapted to supply heat substantially to the combustion region so that the sorption region 7 may be maintained at a lower temperature suitable for sorption of components such as CO₂ and/or water vapor from the gas phase.

During combustion, there is dynamic movement of gas within the process vessel between the combustion region and other regions of the generation and isolation zone, as driven by turbulence within the zone and by axial gradients of concentration and temperature between the combustion region, typically located in a middle section of the generation and isolation zone, and other regions, such as the sorption and/or dehydration region, which are typically located in peripheral sections of the zone. The spacing between the combustion region 5 and the sorption/dehydration region 7 relative to the diameter and wall thickness of the tubular vessel is preferably selected so that environmental heat losses alone establish an axial thermal gradient along the longitudinal axis of the vessel sufficient that the sorption region is at a temperature low enough for effective sorption of CO₂ and/or water vapor. FIG. 5 illustrates a typical gradient wherein the temperature decreases progressively from greater than 350° C., e.g., about 650° C., in the combustion region to well below 100° C., e.g., about ambient, in the sorption region.

Further salient features of the apparatus are described hereinbelow, following detailed description of the process.

In carrying out the process of the invention, a specimen of a condensed phase composition to be analyzed, typically a solid specimen, is introduced into the combustion region within the generation and isolation zone, e.g., by placement in boat 11 within vessel 1. Often, the raw condensed phase composition comprises volatile components, for example a bound reagent that can cause complications in the isotopic analysis. In preferred embodiments of the process, such volatile components are removed by controllably heating the combustion region containing the specimen, exposing it to sub-atmospheric pressure, or both. Preferably gas flow port 17 is connected in gas flow communication to a vacuum pump or ejector via an adjustable orifice (such as a metering valve), and the pressure dynamically reduced to and maintained at less than about 1 torr, preferably less than about 0.1 torr, while heat is supplied by furnace 23 to promote removal of volatiles. Usage of an adjustable valve between process vessel 1 and an external vacuum source limits the movement of intravessel materials during vessel evacuation. The temperature of the specimen during removal of volatiles is typically in the range between about ambient and 250° C. Removal of volatiles may generally require exposure to dynamic vacuum for a period of about 1 to about 50 hours.

As needed for an isotopic determination, a sorbent may be loaded into boat 15 in sorption region 7 prior to evacuation of the generation and isolation zone 3 for removal of volatiles from the specimen. Where this procedure is followed, the sorbent is degassed during the vacuum heat treatment step. Degassing the sorbent functions primarily to remove air. Removal of air is desirable inter alia to avoid contamination of a product fraction with dinitrogen or CO₂ from the air. Where a supplemental reaction agent is used, e.g., a metal oxide as described below, vacuum heating of the combustion region prior to combustion may serve the further purpose of increasing supplemental reaction agent activity by removing adsorbed impurities and converting metal carbonate to metal oxide.

To carry out the combustion step, a primary oxidant, preferably dioxygen (molecular oxygen), is introduced into the generation and isolation zone. Other oxidants, e.g., Cl₂ or O₃, may be used in some circumstances, but molecular oxygen is highly preferred. The dioxygen charge is preferably substantially dry, i.e., containing less than 1 volume % water vapor, preferably less than about 0.01 volume % water vapor, and chemically pure, containing at least 99 volume % O₂, preferably greater than 99.9% by volume, more preferably greater than about 99.995 volume % O₂. In order to minimize the presence of nitrogen from air, the generation and isolation zone is preferably evacuated prior to admission of oxygen, irrespective of whether evacuation is necessary for removal of undesired volatiles from the specimen. Oxygen is thereafter charged to any convenient pressure, for example, 10 to 1000 torr (absolute), more typically 100 to 1000 torr, still more typically about 125 to about 700 torr, and most preferably between about 150 to about 400 torr (absolute). After oxygen is admitted, heat is applied by furnace 23 to heat the specimen to its reactive temperature in contact with dioxygen, thus generating a combustion product gas typically comprising CO₂ and water vapor, or CO₂, water vapor and N₂. Combustion may typically be conducted at a temperature between about 350° and about 1000° C., more typically between about 500° and about 800° C. A modest exotherm is typically expected during combustion. For example, if the furnace is controlled to bring the temperature of the specimen to a temperature in the range of 500° C. to 750° C. for reaction, the exotherm may typically involve an additional 0.5 to 5 kilojoules for organic combustions. Gradual low-temperature combustion, as preferably practiced in the process of the present invention, contrasts with GC-IRMS, which generally utilizes temperature greater than 900° C. for rapid organic combustion. Thus low-temperature combustion significantly simplifies process vessel design and the selection of construction materials. Optionally, a thermocouple (not shown) may be placed in contact with the outer wall of vessel region 5 or even more proximal to boat 11, and the heat generation by furnace 23 controlled in response to the combustion region temperature via a temperature controller (not shown) in order to initiate combustion at a target temperature. However, for routine repetitive processing of specimens of similar composition, furnace output can be controlled based on process operating experience without need for a temperature control loop in solid contact with vessel or specimen. It will be understood by those skilled in the art that if desired, other apparatus controllers may be additionally incorporated into the apparatus without departing from the scope of the invention (such as timer controller, mass flow controller, pressure controller, valve controller, programmable logic controller, or microprocessor).

Complete combustion of the specimen is not necessary. In fact, the process can proceed satisfactorily where the principal combustion step actually comprises a combination of oxidation and pyrolysis, yielding not only CO₂, water and CO as products of combustion, but also hydrogen and carbon under particular conditions. Thus, e.g., the quantity of the specimen relative to the volume of the generation and isolation zone, i.e., the interior of tubular process vessel 1, may be such that a charge of 100% molecular oxygen occupying this zone at 25° C. and 500 torr (absolute) would be stoichiometrically equivalent to about 10% to about 150% of the carbon content of the specimen. The specimen is sized and molecular oxygen charged at such pressure that the measured signal magnitude for dioxygen in the process vessel after combustion/sorption is preferably less than about 50%, more preferably less than 5%, and still more preferably less than 1% of the signal magnitude for product CO₂ or dinitrogen.

Preferably, there are no significant flow restrictions between the combustion and optional sorption and/or dehydration region, nor otherwise within the generation and isolation zone. More preferably, as shown, the combustion and sorption/dehydration regions are contained within a single chamber. As a consequence, no significant pressure drop is observed in flow of gas from the combustion region to the sorption/dehydration region, and sorption or other dehydration step is typically initiated during the combustion phase. As combustion and sorption/dehydration progress, the generation and isolation zone becomes mixed substantially via thermally-driven free convection between the combustion and sorption/dehydration regions, and typically throughout the entire zone. The total pressure within the generation and isolation zone is typically in the range of about 10 and about 1000 torr, more typically between about 25 and about 1000 torr, most typically between about 50 and about 800 torr, during the combustion/sorption cycle. During combustion, the peak pressure may typically be in the range of 100 to 1000 torr, the peak pressure being dependent upon the particular isotopic determination, the reactant quantities, the furnace temperature, the combustion time, etc. A modest positive gauge pressure can assist in preventing ingress of air during combustion and sorption. For example during ¹⁵N-determination, where dioxygen is introduced into the process vessel 1 at an absolute pressure in the range of 400 to 600 torr, peak pressure may be reached at 550 to 1000 torr, after which the pressure declines due to gas sorption and/or reactant depletion. Where combustion and sorption are conducted in a batch mode, the overall batch cycle is typically between about 1 and about 50 hours, more typically between about 2 and about 50 hours.

Preferably, a supplemental reaction agent is provided to promote the chemical conversion of CO and/or NOₓ. Conveniently, the supplemental reaction agent may be present in the combustion zone, e.g., mixed with the specimen in boat 11 at combustion station 9. In such embodiments, the supplemental reaction agent may be mixed with the specimen prior to introduction of the specimen into the combustion region, or mixed with the specimen at the combustion station, e.g., in boat 11, prior to combustion, and ordinarily prior to vacuum heating for removal of volatile components from the specimen. Alternatively, a separate station may be provided comprising a holder for the supplemental reaction agent.

Preferably, the supplemental reaction agent is a transition metal oxide, typically in particulate form with particle size preferably less than about 0.1 mm. Exemplary suitable supplemental reaction agents include Fe₃O₄, CuO, CO₃O₄, or NiO, although mixtures of a given metal oxide plus metal (such as Fe₃O₄—Fe) can also be exploited as supplemental reaction agent mixtures. Peroxides are generally not preferred as supplemental reactants. The supplemental reactant can directly function as an oxidizer of specimen material and/or CO, and may also catalyze the chemical conversion of CO and/or NOₓ. Preferably the specimen, or a mixture of specimen plus supplemental reaction agent, is mechanically pulverized prior to introduction into the process vessel. Preferably, the specimen and supplemental reaction agent may be mixed in a mass ratio between 10:1 and 1:10, more preferably between 5:1 and 1:5, and ordinarily between about 2:1 to 1:2.

The sorption region may comprise a plurality of sorption stages, but does not require a multi-stage separation system such as a chromatographic column. Ordinarily, not more than three sorption stages are needed and, regardless of the number of stages, the sorption region gas-phase is convectively mixed. During analysis for ¹⁵N-content, sorption is preferably conducted in a single stage using a sorbent that is effective for sorption of both water and CO₂. During ¹³C-analysis, an optional sorbent may be utilized to selectively remove water vapor or carbon monoxide. Again sorption is preferably conducted in a single stage. Contact between the gas phase and the sorbent may be effected by allowing the gas to flow over the sorbent bed, e.g., by placing the sorbent in boat 15, rather than through the sorbent bed as in a conventional fixed bed adsorber or packed column. In this way, plugging of flow path is advantageously avoided, pressure drop across the sorbent region is minimized, and free convective gaseous mixing is promoted within the generation and isolation zone.

Any convenient sorbent may be used. It will be understood that the sorption station may comprise an adsorbent, an absorbent, or both. In the case of ¹⁵N determination, preferred sorbents for CO₂ and water include alkali metal oxides such as lithium oxide, sodium oxide and potassium oxide, preferably in an anhydrous state as charged to the sorption station. Lithium oxide is a particularly preferred H₂O and CO₂ sorbent. While sorbent mixtures such as soda-lime can be used if desired, it is generally preferred that strong oxidants not be used. Typically, the solid sorbent may consist of particles sized less than 0.5 mm. Without being limited to any single theory, it is believed that dry alkali metal oxide sorbents may function as either adsorbents or absorbents. Under initial gas/solid contact, the dry alkali metal oxide may function primarily as an adsorbent. However, once an alkali metal oxide sorbent has sorbed a modest quantity of water, a caustic mixture may be formed at the sorption station which can function as an absorbent for both CO₂ and water. In the case of ¹³C-determination, particular sorbents that may be useful for water sorption include anhydrous calcium sulfate, phosphorus pentoxide, activated alumina, and activated silica gel; similarly, an exemplary material that may be useful for carbon monoxide removal at the sorption station is hopcalite.

If desired for purposes of ¹⁵N determination, separate sorbents may be provided at separate sorption stations for CO₂ and water vapor, respectively, within the sorption region. For example, water vapor can be sorbed by anhydrous calcium sulfate at one sorption station, whilst carbon dioxide is sorbed by soda-lime at a separate sorption station. Where a specimen containing sulfur is reacted for purposes of either ¹⁵N or ¹³C determination, a sorbent effective for removal of SOₓ may be provided. Certain metal oxide sorbents are effective for SOₓ removal, for example CaO (quicklime). Where reactive absorption is involved, e.g., between CO₂ and/or SOₓ and alkaline metal hydroxide solution, the quantity of sorbent(s) is preferably at least stoichiometrically equivalent to the total carbon, hydrogen, and sulfur contained in the specimen. Typically, an alkali metal oxide is provided in an excess ratio of at least ten, more typically at least fifteen, with respect to the sum of carbon, hydrogen, and sulfur. If a separate sorbent is provided for water, such as CaSO₄ or P₂O₅, it is preferably provided in stoichiometric excess vs. the hydrogen content of the specimen.

The apparatus of the invention, as typically used in the process for determination of ¹⁵N content, enables recovery of a nitrogen gas fraction that is substantially devoid of CO₂ without the necessity of using a cold trap. Avoidance of cold traps significantly simplifies the process and apparatus for isotopic determination. However, it will be understood by those skilled in the art that, if desired, a containment module can be provided, either ported to the tubular process vessel (for example such a module may be sealably connected via port 19), or as an appendage to the vessel or connected between process vessel and spectrometer during discharge of the nitrogen gas fraction to a mass spectrometer, or in a combination of two or more such arrangements. The use of a sorbent material positioned at a favorable location along the axial temperature gradient, i.e., a temperature environment in which sorption equilibria and mass transfer rates are conducive to sorption, is desirable for most applications, and the removal of H₂O, CO₂, and/or SOₓ by sorption rather than by cold trap represents a significant advantage of various preferred embodiments of the present invention.

The generation and isolation zone within tubular process vessel 1 is preferably configured so that environmental heat losses during combustion cause sorption to take place at a temperature less than 100° C., preferably less than about 50° C., typically at ambient or slightly above. Optionally, the sorption region may be cooled by forced circulation of ambient air around the portion of the tubular process vessel surrounding the sorption region, or by circulation of another cooling fluid, e.g., cooling water or coolant gas through an annular jacket surrounding the sorption region. The pressure in the sorption region is essentially the same as in the combustion region, i.e., during the combustion step. During ¹⁵N-determination it may typically rise early in the process to a peak level in the range 550 to 1000 torr, then drop back, e.g., to a level in the range of 10 to 500 torr as gaseous material is sorbed. Pressures in these ranges are generally suitable for effecting sorption of water vapor and/or CO₂.

Because combustion is practically conducted with a slight deficiency or slight excess of oxidant, combustion of the specimen is not necessarily complete. Often the specimen may partly char during combustion instead of being entirely consumed. Under such conditions, most NOₓ generated during the combustion may typically be reduced by reaction with carbon, transient CHₓ species, or transient NHₓ species produced by combustion. The presence of H₂ (dihydrogen) has been conditionally observed in the product carbon oxide or dinitrogen gas fraction, indicating that hydrogen species could also have a role in reducing NOₓ or inhibiting its formation. Moreover, within a preferred combustion temperature range, e.g., 500° C. to 750° C., even nascent NOₓ formation may not be favored. In any event, the carbon oxide or nitrogen gas fraction appropriately produced in accordance with the invention does not typically contain any substantially interfering fraction of NOₓ. In addition to the potential function of carbon char, CHₓ species, NHₓ species, and/or hydrogen as reductants, a metal oxide used as a supplemental reactant may conceivably function as a catalyst for the decomposition of NOₓ to N₂ and O₂. As a still further possibility, some NOₓ might be captured in the sorption region by the sorbent for water vapor and/or CO₂.

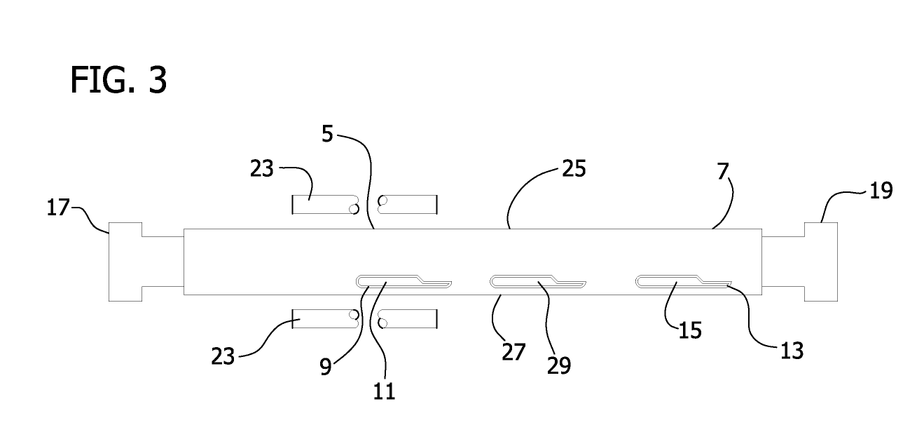

Alternatively, as illustrated schematically in FIG. 3, a reduction region 25 may be established in the generation and isolation zone containing a reductant for reduction of NOₓ to N₂. Such a reduction region is preferably spaced from both the combustion region, and from any sorption region, and typically is positioned therebetween. Referring to FIG. 3, the reduction region 25 comprising a reduction station 27 is located along the longitudal axis of the generation and isolation zone within the tubular vessel 1 at a location wherein the thermal gradient establishes temperature that may be optimal for the reduction of NOₓ. Typical reductants that may be provided at reduction station include iron powder, copper powder, nickel powder, or platinum/rhodium on alumina, which may typically be held at the reduction station in boat 29. Preferably, the reduction region is so located that the temperature within that region during combustion is between about 400° C. and about 750° C.

In preferred embodiments of the invention, as combustion and sorption proceed, the gas phase equilibrates by free convective axial (longitudinal) and radial back mixing so that the composition of the gas phase becomes substantially steady-state throughout the generation and isolation zone. After combustion and any sorption or other dehydration step(s) have been completed in the course of a ¹³C determination, a product carbon oxide gas fraction is obtained wherein the sum of the H₂ and CO content is preferably not greater than about 5 volume %, more preferably not greater than about 1 volume %, basis CO₂. Though the ¹³C-process can proceed stoichiometrically deficient of dioxygen, it is preferred that the combination of combustion and sorption/dehydration conditions be such that the sum of the water vapor content, CO content and H₂ content is not greater than about 10 volume %.

After the combustion and sorption steps are complete in the course of ¹⁵N determination, a product dinitrogen gas fraction is obtained wherein the sum of the water vapor content and CO₂ content is not more than about 5 volume %, preferably not more than 1 volume %, and more preferably not more than 0.5 volume %. Preferably, the carbon monoxide content is not more than about 0.5 volume %, more preferably not more than about 0.2 volume %. It is desirable to establish both a low CO content and a low CO₂ content, especially for higher precision determinations because at typical ionization conditions CO₂ tends to fragment into CO and oxygen in a mass spectrometer. While ¹²C¹⁶O₂ as such, which has a nominal mass of 44, does not directly interfere with the determination of ¹⁵N, any ¹²C¹⁶O (nominal mass=28) or ¹³C¹⁶O (nominal mass=29), whether present in the sample or formed within the spectrometer, has a deleterious effect. A sorbent or combination of sorbents effective for removal of both CO₂ and water is preferred because the presence of water vapor can apparently influence the process conversion of CO to CO₂. Preferably, the product nitrogen gas fraction is essentially free of NOₓ, a result that is achievable on the basis described hereinabove.

On the basis of actual process results, it is preferred that a product nitrogen gas fraction contains minimal quantities of both dioxygen and dihydrogen (that is, minimal amounts of gaseous oxidant and reductant).

Because molecular oxygen has nominal molecular masses of 32 through 36, the presence of a minor proportion of dioxygen and/or dihydrogen in the product nitrogen gas fraction does not directly affect mass spectral analysis. For purposes of ¹⁵N-determination, it is preferred that the dioxygen content be not greater than about 50 volume % in the product gas, more preferred that the dioxygen content be not greater than 5 volume %, even more preferred that the dioxygen content be not greater than 1 volume %. With regard to residual hydrogen gas after combustion, it is preferred that the dihydrogen content be not greater than 5 volume % or more preferably not greater than 1 volume %.

For purposes of ¹³C determination, it is preferred that the dioxygen content of the carbon oxide gas fraction comprise not more than about 50 volume %, more preferably no more than about 10 volume %, still more preferably not more than about 5 volume %, most preferably no more than about 1 volume %.

In the system described above, an appropriate thermal gradient, such as that illustrated in FIG. 5, is achieved on a batch basis in a single carbon oxide or N₂ generation and isolation zone, e.g., within the single chamber of a tubular process vessel, and is achieved in part by selection of process vessel geometry. Thus, the process of the invention does not require passage of the gas phase sequentially through a series of discrete segregated temperature zones, nor does the apparatus need to provide for chromatographic operation or precise synchronization of carbon oxide or N₂ generation and mass spectrometric analysis. In accordance with the description set out above, a satisfactory temperature gradient between the combustion and other stations may be achieved by appropriate selection of furnace power, furnace configuration, reactant quantities, and L/D (length to diameter) aspect of the zone. Positive temperature control at the specimen itself is generally not required, though if desired temperature control can be provided by placing a temperature sensor near specimen boat 11 and provide a temperature controller (not shown) to regulate the power input to furnace 23 in response to a signal from the sensor to control local temperature in the combustion region during vacuum heating and/or combustion. Based on these principles, those skilled in the art may readily select appropriate dimensions for the tubular process vessel and spacing of sorption region from the combustion region therein, and thus to establish a desired temperature profile along the longitudinal axis of the generation and isolation zone within a tubular process vessel, such as, for example, the profile illustrated in FIG. 5.

It will be understood that FIG. 5 illustrates a representative intravessel temperature profile with respect to distance along the longitudinal axis at a time prior to any substantial chemical reaction. A plot might also be prepared of the temperature profile with respect to reaction time at a particular point along the longitudinal axis. However, since chemical reaction is conducted on a batch basis at temperatures typically below 900° C., the exact temperature versus time profile within the combustion region, or in the intermediate region between the combustion region and the sorption region, is not narrowly critical. Based upon the apparatus design, environmental heat losses ensure that the sorption/dehydration region either is consistently in a temperature range (see FIG. 5) whereby sorption of gaseous water vapor and/or CO₂ is substantial or else cools to an effective sorption temperature range during the batch cycle so that equilibration by convection within the gas phase in the carbon oxide or N₂ generation and isolation zone results in substantial sorption of water vapor (and CO₂ in the case of ¹⁵N determination) components of the gas phase by the completion of a process cycle.

After the combustion and sorption cycle is complete, the process vessel containing the product nitrogen gas fraction may be wheeled to the location of a mass spectrometer, and a sample comprising at least a portion of the carbon oxide or nitrogen gas fraction introduced into the injection port of the spectrometer. The ¹⁵N-isotopic content of a sample, and thus of the nitrogen contained in the specimen, is ordinarily determined from mass spectrometric signals observed at nominal m/z ratios 30, 29, and 28 (N₂), though it is conditionally conceivable that spectrometric signals at nominal m/z ratios 15, 14.5, and 14 (N₂²⁺) might instead be utilized for ¹⁵N-determination. It has been found that, when the apparatus of FIG. 2 or 3 is operated in accordance with the process of the invention under preferred conditions, the net spectrometric signal for ¹⁵N₂⁺ (m/z 30) is typically more than twenty times greater than the combined signals for ¹²C¹⁶O₂⁺ (m/z 44) and water vapor (m/z 18). However, as those skilled in the art will understand, the presence of minor fractions of CO₂, H₂O, NOₓ and/or SOₓ does not prevent the process and apparatus from providing useful data for ¹⁵N-determinations.

In combination, the process and apparatus are useful for performing ¹³C or ¹⁵N-determinations of various uniformly isotope-enriched specimens. A major advantage of the invention is capability to controllably vacuum heat treat a carbonaceous and/or nitrogenous specimen within the process vessel itself, some controllable parameters being intravessel pressure, treatment temperature, and treatment time. The vacuum heat treatment step, performed prior to and within the same chamber as combustion, primarily functions to remove natural abundance volatile materials from the condensed phase specimen. Thereby the measured ¹³C or ¹⁵N-content of a treated specimen is representative of the actual analyte. Advantageously, any supplemental reaction agent (such as Fe₃O₄) that may be mixed together with specimen in a first station within the combustion region can be activated simultaneously during the vacuum heat treatment step. After the combustion cycle is complete, the process vessel containing the combustion product gas may be wheeled near a mass spectrometer, and some portion of the product gas introduced into the spectrometer injection port. The ¹³C-isotopic content of a sample, and thus of the corresponding specimen, is preferably determined from mass spectrometric signals observed at nominal m/z ratios 44, 45, 46, 47, 48, and 49 (CO₂ ions). Alternatively however, it may be desirable in particular cases to instead determine sample ¹³C-content derived from mass spectrometric signals at nominal m/z ratios 28, 29, 30, and 31 (CO ions), or derived from signals at nominal m/z ratios 12 and 13 (C₁ ions).

Referring again to the apparatus as depicted in FIG. 2, tubular process vessel 1 is preferably formed as a single fused glass pipe composed of cylindrical segments. A tubular combustion region segment 31 surrounding combustion station 9 is preferably constituted of a glass such as fused silica glass that is capable of withstanding combustion temperatures in excess of 500° C., preferably in excess of 750° C. A tubular transition glass segment 33 is fused at its inward end to combustion region segment 31 and at its outward end to gas flow socket 36. Socket 36 is conveniently constructed of borosilicate glass, and can be internally threaded for sealable connection to a vacuum source, molecular oxygen source, gas manifold or gas analyzer. In the apparatus as shown, socket 36 is adapted for threaded connection to a flanged bushing 35 that is in turn adapted for connection to tee 45 leading to the vacuum source, molecular oxygen source, gas analyzer or gas manifold. At its inward end (where it is fused to the combustion segment), the composition of the transition glass segment is such that any difference between its coefficient of thermal expansion and that of the combustion region segment is small enough so that the joint between the combustion region segment and the transition segment remains substantially stable when the combustion region is repetitively cycled between ambient temperature and peak combustion temperature, e.g., between ambient temperature and 500° C., or 650° C., or 750° C., in the case of ¹³C determination at least 700° C. The transition segment may be entirely constituted of a uniform glass composition, or may be comprised of a plurality of segments of differing composition which are fused together.

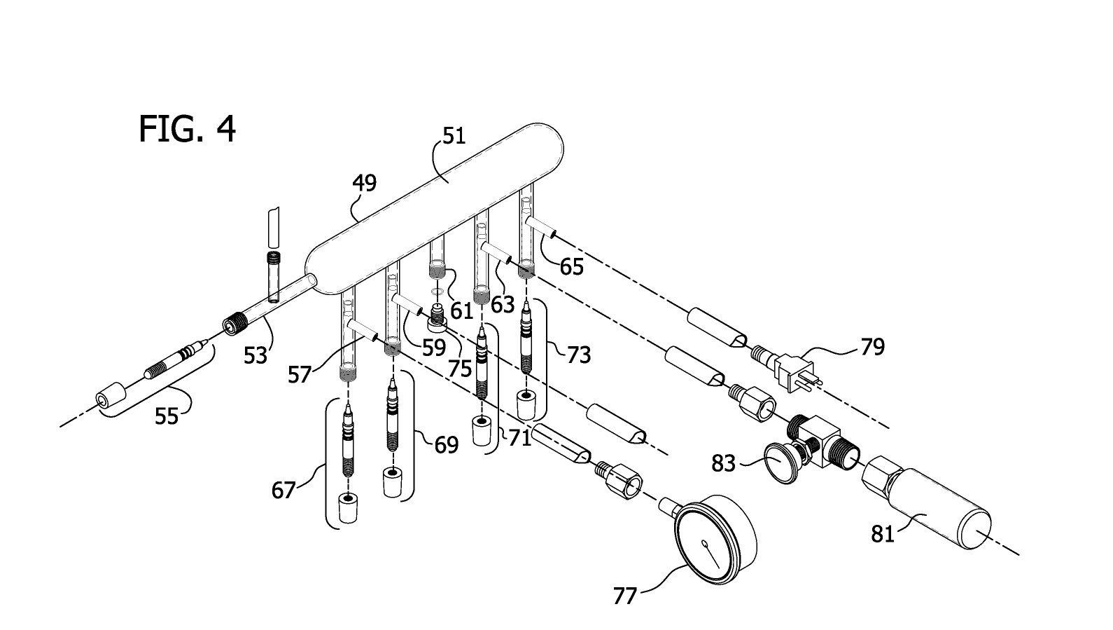

One or more O-rings 37 may assist in hermetically sealing the connection between socket 36 and bushing 35. The primary gas port 17 comprising socket 36 is adapted for gas flow connection to a source of molecular oxygen, a gas analyzer, a vacuum source or a gas manifold such as that illustrated in FIG. 4. Structurally, bushing 35 comprises a flange, threaded socket or threaded nipple adapted for direct connection to a mating flange, threaded nipple or threaded socket on a conduit which can provide gas flow communication between process vessel 1 and a source of molecular oxygen, a gas analyzer, a vacuum source or a gas manifold.

Combustion region segment 31 preferably extends beyond combustion station 9 in both longitudinal directions, i.e. in the direction of both port 19 and port 17. This dual extension typically extends beyond the region to which heat is actively supplied by furnace 23, and thus provides intermediate regions within which the temperature may progressively decrease from peak combustion temperature to a temperature favorable for selective sorption and/or condensation during the combustion cycle, as illustrated in FIG. 5. If the apparatus includes a reduction station 27 as illustrated schematically in FIG. 3, the reduction station and boat 29 for holding a reductant are preferably contained within this extension of the tubular combustion region segment. Another tubular transition glass segment comprising a sorption/dehydration region segment 39 is fused at one end to the combustion region segment 31 (in the embodiment of FIG. 2 at the end of segment 31 opposite its connection to transition segment 33). At the inward end of transition segment 39 (where it is fused to the combustion segment), the material of construction of segment 39 is such that any difference between its coefficient of thermal expansion and that of the combustion region segment is small enough that the joint between the combustion region segment and the transition segment remains substantially stable when repetitively cycled through successive combustion cycles (in practice an individual vessel has exceeded 100 process cycles). As indicated in FIG. 5, however, the maximum temperature attained within sorption/dehydration region 7 is substantially lower than the maximum temperature reached at the joint between combustion region segment 31 and sorption/dehydration region segment 39.

Secondary access port 19 comprising threaded socket 38 at the outer end of sorption region segment 39 is adapted for direct connection to a threaded and flanged bushing 41. The latter connection may be established with the assistance of one or multiple O-rings 43. By appropriate combination of tube, bushing, O-ring, and socket subassemblies, the apparatus of the invention is effectively sealed against influx of contaminating air, without the necessity of vacuum grease.

Tee 45 (FIG. 2) may be connected in fluid communication with the interior chamber defining the N₂ generation and isolation zone 3 within process vessel 1 for delivery of primary oxidant (e.g., dioxygen) and to provide connection to a vacuum source (not shown) for evacuation of the vessel during vacuum heat treatment of the specimen and/or for removal of air prior to introduction of primary oxidant. As illustrated, the side run of tee 45 is adapted for connection to process vessel 1, one end of the straight run is adapted for stem accommodation of metering subassembly 47, and the other end of the straight run is for connection to either a gas manifold (e.g., manifold 49 of FIG. 4) or a gas analyzer. Metering subassembly 47 may serve to regulate the introduction of dioxygen prior to combustion, and as a block valve to isolate the chamber within process vessel 1 from introduction of any extraneous gases during the combustion and sorption phases of the process. Although not shown, another metering valve may serve to connect the chamber via port 19 to a containment module containing a condensed-phase carbonaceous and/or nitrogenous specimen, or to other extra-vessel devices, or to isolate the chamber from extra-vessel gases.

Illustrated in FIG. 4 is a gas manifold 49 which may be connected in fluid communication with process vessel 1 to alternately or simultaneously provide several different functions, for example: (i) delivery of primary oxidant to the carbon oxide or N₂ generation and isolation zone 3; (ii) connection of the chamber to a vacuum source; and (iii) measurement of pressure within the manifold, which essentially reflects the pressure within the tubular process vessel when manifold and vessel are connected and valving between them is open. Manifold 49 comprises a header 51 having a tee 53 at one end thereof. The side run of tee 53 is adapted for connection to a vacuum source while the straight run of the tee opposite the header is adapted for stem accommodation of metering subassembly 55. Thus, gas manifold 49 is a multipurpose module for providing vacuum service to process vessel 1 or for providing gas flow communication to process vessel 1.

Referring to FIG. 4, each of a plurality of side arms 57, 59, 63 and 65 connects to a correspondent header arm, each sidearm being subject to access or closure via metering subassemblies 67, 69, 71 and 73. As needed, header arm 61 can be either sealed with plug 59 or otherwise employed. Further connections via these valves and side arms enable the manifold to provide the various functions mentioned above. For example, a compound pressure gauge 77 is shown as connected to sidearm 57, an electronic tube 79 for communication with a thermal conductivity gauge is shown as connected to sidearm 65, and an oxygen supply cylinder 81 is shown as connected via cylinder valve 83 to sidearm 63. The thermal conductivity gauge may be used for low-pressure measurement. Tee 45 may be connected to sidearm 59 during process operations, whilst header arm 61 is sealably closed by plug 75.

It has been found convenient for process vessel 1 to have an internal volume in the range of 0.02 to 2 liters, more conveniently 0.05 to 0.5 liters, advantageously between about 0.1 and about 0.25 liters. In such instance, the amount of specimen charged to combustion station 9 may typically be in the range between about 15 mg and about 1.5 g, more typically between about 25 mg and about 500 mg, most typically between about 50 mg and about 250 mg, where O₂ is initially charged to a pressure of about 100 to about 800 torr. The supplemental reaction agent charge is preferably within the range between about 5 mg and about 1.5 g, between about 50 mg and about 500 mg, or between about 100 and about 250 mg. At the scale defined by the aforesaid quantities of specimen and a preferred process vessel L/D aspect between about 10 and about 250, the distance from combustion station 9 to sorption station 13 is preferably between about 5 cm and about one meter, more preferably between about 10 cm and about 75 cm, more typically between about 15 cm and about 50 cm.

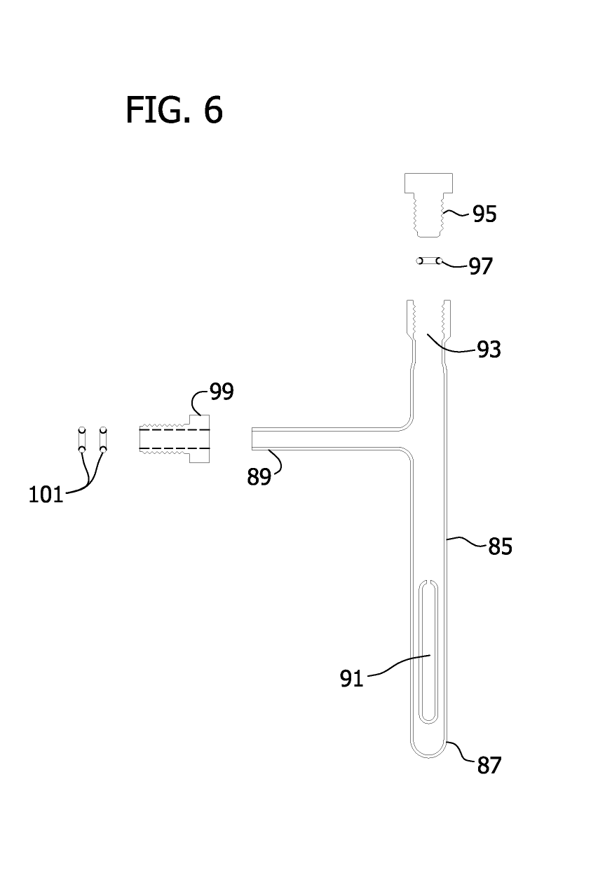

Illustrated in FIG. 6 is a specimen containment module 85 that is adapted to be attached in fluid flow communication with secondary access port 19 of the tubular process vessel as illustrated in either FIG. 2 or FIG. 3. The module comprises a tubular container 87 having a sidearm 89 for communication with the interior of process vessel 1. Typically, container 87 is disposed vertically. A holder 91 for a condensed phase specimen is located within the lower leg of container 87 below the level of sidearm 89. The container has a port 93 at its upper end for introduction of a specimen. Holder 91 is preferably removable from the container so that the specimen can be placed in the holder outside the container, after which the holder and specimen are placed inside the container. Port 93 may be threaded (internally as shown in the drawing, or externally) to receive a plug 95 comprising a threaded plug (as shown) or cap to close the module after the specimen is introduced. The closure is conveniently sealed with an O-ring 97. The sidearm may be connected to a threaded socket at secondary access port 19 via a bushing 99 sealed with O-rings 101. In practice, a volatile specimen might be loaded into holder 91, the charged holder then placed inside container 87, port 93 sealed, and sidearm 89 sealably attached to vessel 1. By controlled cooling of the lower container leg 85, said volatile specimen may be condensed (thus contained) so that such condensed specimen can be vacuum degassed prior to any dioxygen addition. Afterward, an auxiliary heater (not shown) might be utilized to vaporize the specimen which then flows through sidearm 89 into the interior of tubular process vessel 1 wherein it is combusted as described above. The resultant product gas is convectively mixed within process vessel 1. Optionally, an adequately volatile specimen may be vaporized into ambient intravessel dioxygen prior to initiation of combustion. For purposes of ¹⁵N determination, CO₂ and water are sorbed by sorbent contained by boat 15. For purposes of ¹³C determination, water vapor may optionally be removed by sorption to a sorbent contained in boat 15. Alternatively, water vapor may be condensed in a cold trap located at approximately the same position as boat 15 relative to specimen boat 11. As necessary, process vessel 1 may contain a reductant in boat 29 as illustrated in FIG. 3 for NOₓ decomposition.

The apparatus and process of the invention are adapted for conducting a relatively high volume of repetitive isotopic determinations. After each combustion cycle, combustion and sorption cycle, or combustion and water vapor condensation cycle, the apparatus may be cleaned and re-used to generate and isolate another carbon oxide or N₂ fraction. The interior of the vessel and the quartz boats may be cleaned with a brush and abrasive, after which fresh sorbent may be supplied to the sorption station and a new specimen, mixed with fresh supplemental reaction agent as needed, may be supplied to the combustion station. By use of boats for specimen and sorbent, the apparatus may be readily re-used without laborious repacking of reactors, sorption columns, and the like. Moreover, the process vessel/furnace module can be mobile thus easily transported and attached to available gas analyzers and manifolds. The unified reactor/sorption process pipe is refractory, transparent and grease-free. Greaseless connections eliminate any possible isotopic contamination from grease usage and they facilitate apparatus cleanup and re-use.

The use of boats for specimen, supplemental reaction agent, sorbent and reductant minimizes movement of any of these materials outside its proper region during combustion and sorption operations.

Gastight process vessel 1 also affords convenient storage of the carbon oxide or nitrogen fraction pending analysis by mass spectrometry or alternative techniques. For example, in higher volume operations, a plurality of process vessels may be used to generate a plurality of carbon oxide or N₂ fractions which can be accumulated to be run successively through a single mass spectrometer. This allows the mass spectrometer to be usefully employed in making other analyses, if desired, without compromising analyses of specimens for ¹³C or ¹⁵N content. The sample or accumulated samples of carbon oxide or nitrogen gas fraction may be analyzed at any time as determined by instrumentation availability.

The apparatus and process of the invention are capable of making ¹³C and ¹⁵N determinations with accuracy and analytical precision. In various preferred embodiments, however, the process and apparatus of the invention are not designed for ultra-precise isotopic analysis equivalent to that provided by a GC-IRMS system. Generally, the system is adapted to determine overall ¹³C or ¹⁵N condensed-phase specimen content, being reproducible to about 0.1 atom % ¹³C or ¹⁵N. At this level of precision, which is entirely sufficient for most ¹³C or ¹⁵N-enriched commercial materials and many research applications, the apparatus can be provided at modest cost for processing of a high volume of either routine samples or samples for which such precision is otherwise satisfactory. Because of its batch operation and lack of multi-stage adsorption, the apparatus of the invention is not typically used for determination of both carbon and nitrogen isotopic ratios on the same sample. However, if desired, the apparatus and process might be adapted to firstly measure ¹⁵N-isotopic content of a sample as described, next remove residual gases from the process vessel, and afterward desorb or by some other mechanism liberate carbonaceous gas from a sorbent at sorbent station 13 and in this manner secondly measure the ¹³C-isotopic content for the same sample.

The natural abundance of ¹⁵N is about 0.4 atom %. The process of the invention is particularly effective for determination of ¹⁵N isotope content in a specimen wherein ¹⁵N constitutes between about 5 atom % and about 99.5 atom % of the total nitrogen present. For determinations at the lower and especially at the upper end of this range, or anywhere in the range where maximum precision is desired, the water, CO and CO₂ content are preferably as low as practicable. However, over a wide spectrum within the range, and depending on the purpose and use of the analytical data, analyses of practical value may be achieved even though the nitrogen sample contains minor concentrations of CO₂, water, or even CO.

The process and apparatus of the invention are effective for measurement of the ¹³C-proportion where ¹³C constitutes between about 5 atom % and about 99.5 atom % of the total sample carbon present. The natural abundance of ¹³C is about 1.1 atom %. For samples in which the ¹³C-content approaches either extreme, it is desirable to utilize relatively pure O₂ for combustion and to further utilize a supplemental reactant that converts CO to CO₂, thereby increasing the proportion of CO₂ in the combustion product gas.

Additional logistical advantages can be afforded by the preferred use of a general-purpose mass spectrometer, such as (but not limited to) quadrupole-based spectrometers, as made feasible by the process and apparatus of the invention. Although special isotope ratio mass spectrometers can provide exceptionally high precision, they are not generally versatile, being adapted for simultaneous determination of only 3 or 4 different masses. Thus, when there is less than a constant demand for isotope ratio analyses, these highly specialized and expensive instruments may be idle. By contrast, a process gas mass spectrometer is a versatile instrument having a typical scanning range of m/z 2 to 250 or higher; and may, thus, be used for a wide variety of other applications in addition to the isotopic ratio determinations that are made according to the process of the invention.

The invention having been described in detail, it will be apparent that modifications and variations are possible without departing from the scope of the invention defined in the appended claims.

### EXAMPLES

The following non-limiting examples are provided to further illustrate the present invention.

### Example 1

### Glycine-¹⁵N

Glycine-¹⁵N specimen (0.15-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1,5-gram) was loaded into quartz boat 15 within the sorption region of the vessel. Next the secondary vessel access port was plugged, the process vessel shielded, and the reactants then subjected to dynamic vacuum heat treatment (VHT) at 75° C. for at least one hour. Subsequently about 600-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for greater than 22 hours, the reactor-furnace assembly was sealably connected to the inlet of a quadrupole mass spectrometer. Some of the resultant product gas was metered into the mass spectrometer and analyzed. The average nitrogen isotopic result thus obtained was 99.2±0.1 atom % ¹⁵N. The chemical precursor associated with this particular glycine-¹⁵N was specified to be 99.3 atom % ¹⁵N.

### Example 2

### Biosynthesized Lyophilized Protein-¹⁵N

Biosynthesized lyophilized protein-¹⁵N specimen (0.15-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1,5-gram) was loaded into quartz boat 15 within the sorption region of the vessel. Next, the secondary vessel access port was plugged, the process vessel shielded, and the reactants then subjected to dynamic VHT at 250° C. for at least ten hours. Subsequently about 600-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for greater than 24 hours, the reactor-furnace assembly was sealably connected to the inlet of a quadrupole mass spectrometer. Some of the resultant product gas was metered into the mass spectrometer and analyzed. The average nitrogen isotopic result thus obtained was 99.0±0.1 atom % ¹⁵N. The chemical precursor associated with this batch of glycine-¹⁵N was specified to be 99.2 atom % ¹⁵N.

### Example 3

### Nitrophenol

Para-nitrophenol specimen (0.13-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1,5-gram) was loaded into quartz boat 15 within the sorption region of the vessel. Next, the secondary vessel access port was plugged, the process vessel shielded, and the reactants then subjected to dynamic vacuum treatment at ambient temperature for about 0.5-hour. Subsequently about 250-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for about 24 hours, the reactor-furnace assembly was sealably connected to the inlet of a quadrupole mass spectrometer. Some of the resultant product gas was metered into the mass spectrometer and analyzed. The nitrogen isotopic result thus obtained was 0.5 atom % ¹⁵N. Natural isotopic abundance for nitrogen is about 0.4 atom % ¹⁵N.

### Example 4

### Lyophilized Algal Cells-¹⁵N

Lyophilized algal cell-¹⁵N specimen (0.08-gram) and Fe₃O₄ (0.15-gram) were loaded into quartz boat 11 within the combustion region of a tubular process vessel (internal volume 0.15-liter with L/D 60) typical of that depicted in FIG. 2. Anhydrous lithium oxide (1,5-gram) was loaded into quartz boat 15 within the sorption region of the vessel. Next, the secondary vessel access port was plugged, the process vessel shielded, and the reactants then subjected to dynamic VHT at 250° C. for at least ten hours. Subsequently about 250-torr dioxygen was charged into the vessel and the latter sealed. The combustion region peak temperature was then gradually increased from ambient to 650° C. by activating an electrical resistance furnace. Sorption region temperature ranged from ambient to less than 50° C. during combustion. After allowing the combustion reaction to proceed for about 24 hours, the reactor-furnace assembly was sealably connected to the inlet of a quadrupole mass spectrometer. Some of the resultant product gas was metered into the mass spectrometer and analyzed. The average nitrogen isotopic result thus obtained was greater than 98.8 atom % ¹⁵N.

### Example 5

### Lyophilized Protein-¹³C

Biosynthesized lyophilized protein-¹³C specimen (0.105-gram) was loaded into quartz boat 11 within the combustion region of a tubular process vessel (internal volume 0.15-liter with L/D 60) typical of that depicted in FIG. 2. Next the secondary vessel access port was plugged, the process vessel shielded, and the specimen then subjected to dynamic VHT at 250° C. for at least ten hours. Subsequently about 370-torr dioxygen was charged into the vessel and the latter sealed. The combustion region peak temperature was then gradually increased from ambient to 700° C. by activating an electrical resistance furnace. After allowing the combustion reaction to proceed for greater than one hour, the reactor-furnace assembly was sealingly connected to the inlet of a quadrupole mass spectrometer. Some of the resultant product gas was metered into the mass spectrometer and analyzed. The average carbon isotopic result thus obtained was 99.0±0.1 atom % ¹³C. The amino acid mixture associated with this batch of bio-protein was similarly measured to be 99.1±<0.1 atom % ¹³C.

### Example 6

### Algal Cells-¹³C

Algal cells-¹³C specimen (0.100-gram) was loaded into quartz boat 11 within the combustion region of a tubular process vessel (internal volume 0.15-liter with L/D 60) typical of that depicted in FIG. 2. Next the secondary vessel access port was plugged, the process vessel shielded, and the specimen then subjected to dynamic VHT at 250° C. for at least ten hours. Subsequently about 250-torr dioxygen was charged into the vessel and the latter sealed. The combustion region peak temperature was then gradually increased from ambient to 700° C. by activating an electrical resistance furnace. After allowing the combustion reaction to proceed for greater than one hour, the reactor-furnace assembly was sealingly connected to the inlet of a quadrupole mass spectrometer. Some of the resultant product gas was metered into the mass spectrometer and analyzed. The carbon isotopic result thus obtained was 99.1±0.1 atom % ¹³C. The chemical precursor associated with this batch of algal cells was reported to be 99.3 atom % ¹³C.

### Example 7

### Starch-¹³C

Starch-¹³C specimen (0.105-gram) from Solanum tuberosum was loaded into quartz boat 11 within the combustion region of a tubular process vessel (internal volume 0.15-liter with L/D 60) typical of that depicted in FIG. 2. Next the secondary vessel access port was plugged, the process vessel shielded, and the specimen then subjected to dynamic VHT at 200° C. for at least twelve hours. Subsequently about 250-torr dioxygen was charged into the vessel and the latter sealed. The combustion region peak temperature was then gradually increased from ambient to 700° C. by activating an electrical resistance furnace. After allowing the combustion reaction to proceed for greater than 75 minutes, the reactor-furnace assembly was sealingly connected to the inlet of a quadrupole mass spectrometer. Some of the resultant product gas was metered into the mass spectrometer and analyzed. The average carbon isotopic result thus obtained was 98.3±0.1 atom % ¹³C. This particular solid starch product was specified by its supplier to be >97 atom % ¹³C.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A process for isolating a carbon fraction representative of the carbon contained in a specimen of a condensed phase carbonaceous composition, said fraction being isolated in the form of a carbon oxide gas that may be introduced into a gas analyzer for determining the carbon isotope proportion of said composition that is constituted by ¹³C, the process comprising:
removing volatile materials from said specimen under vacuum;
contacting said specimen comprising said condensed phase composition or a vapor generated from said condensed phase composition with a primary oxidant in a combustion region within a zone for generation and isolation of a carbon oxide derived from carbon contained in the specimen;
reacting said specimen in said combustion region to generate a combustion product gas comprising carbon oxides and water; and
determining the ¹³C-isotope content of a carbon oxide gas fraction or a sample thereof produced in said generation and isolation zone, said carbon oxide gas fraction comprising said combustion product gas or a gas fraction obtained by modifying the composition of the combustion product gas.

2. A process as set forth in claim 1 wherein said specimen is substantially uniformly enriched in ¹³C-isotope and is selected from the group consisting of algal cells, amino acids, peptides, proteins, protein extracts, starch, organic chemicals and elemental carbon.

3. A process as set forth in claim 1 wherein said carbon oxide gas fraction is produced in said generation and isolation zone and is transferred from said zone to a mass spectrometer, the isotopic measurement precision of said process being about ±0.1 atom % ¹³C.

4. A process as set forth in claim 1 wherein said generation and isolation zone is contained in a tubular process vessel within which the gas phase equilibrates by mixing during combustion, equilibration of the gas phase comprising free convective mixing.

5. A process as set forth in claim 1 wherein said generation and isolation zone is closed against introduction of gas from an extraneous source during combustion of said specimen, said generation and isolation zone comprising a plurality of functional regions, including one or more functional regions other than said combustion region, said regions being contained at discrete locations within said carbon oxide generation and isolation zone.

6. A process as set forth in claim 1 further comprising:
introducing said condensed phase specimen of said composition into said combustion region; and
heating said specimen under vacuum and removing said volatile components within said isolation and generation zone.

7. A process as set forth in claim 6 wherein a longitudinal temperature gradient prevails within said generation and isolation zone, the temperature progressively decreasing between said combustion region and one or more other functional regions contained within said zone, said other regions being selected from the group consisting of a region for conversion of CO to CO₂, a region for destruction of nitrogen oxides, and a sorption region.

8. A process as set forth in claim 1 wherein said combustion region of said generation and isolation zone is contained within a single chamber of a tubular process vessel, and said process comprises a further operation or function conducted within said single chamber, said further operation or function being selected from the group consisting of: removing volatile components from said specimen prior to combustion thereof; conversion of CO contained in the combustion product gas to CO₂, destruction of nitrogen oxides contained in the combustion product gas; removing water vapor from the gas phase; storing said carbon oxide gas fraction; and combinations thereof.

9. A process as set forth in claim 1 wherein dioxygen for combustion of said specimen is charged to said generation and isolation zone in a quantity that generates a combustion product gas substantially comprising carbon dioxide and containing minor proportions each of dihydrogen, carbon monoxide, and nitrogen oxides.

10. A process as set forth in claim 7 wherein said carbon oxide gas fraction substantially comprises carbon dioxide, the carbon monoxide content of said fraction being less than about 10 volume %, and the sum of the carbon monoxide content, dihydrogen content, and nitrogen oxides content being not more than about 15 volume %.

11. A process as set forth in claim 1 wherein carbon monoxide generated by combustion is contacted with a supplemental reaction agent comprising a reactant or a catalyst for conversion of carbon monoxide to carbon dioxide, said supplemental reaction agent being selected from the group consisting of Fe₃O₄, CuO, CO₃O₄, NiO and mixtures thereof, the carbon oxide gas fraction produced in said generation and isolation zone containing not more than about 5 volume % carbon monoxide.

12. A process as set forth in claim 7 wherein combustion is conducted in a batch mode within said generation and isolation zone, dioxygen being charged to said generation and isolation zone in a proportion between about 10% and about 150% of an amount stoichiometrically equivalent to the carbon content of the specimen and, during combustion of the specimen, the pressure in the generation and isolation zone is between about 100 and about 1000 torr and the temperature in the combustion region is between about 500° C. and about 750° C.

13. A process as set forth in claim 1 wherein neither said combustion product gas nor other carbon oxide gas fraction produced in said generation and isolation zone is subjected to chromatographic separation.

14. Apparatus for isolating a fraction representative of the isotope distribution of an element or the proportion of a particular isotope of an element contained in a specimen of a condensed phase composition, said fraction being isolated in the form of a gas that may be introduced into a gas analyzer for determining the proportion of a particular element contained in said composition that is constituted by a particular isotope of that element, the apparatus comprising:
a tubular process vessel having a primary gas port for influx of a primary oxidant gas and/or efflux of a gas containing said element that is generated by combustion within the vessel;
a first station within said vessel for receiving a condensed phase specimen of a condensed phase composition, said first station being spaced from said port with respect to the longitudinal axis of said vessel; and
a furnace for heating said condensed phase composition in the presence of a primary oxidant to effect combustion of said specimen and generation of a combustion product gas comprising isotopes of said element.

15. Apparatus as set forth in claim 14 wherein said primary gas and secondary access ports of said tubular process vessel are adapted to be sealingly plugged or in communication via a gastight seal with a valve, transducer, sensor, flow adapter, gas analyzer, mass spectrometer, a manifold having a plurality of other ports, another functional device, or combinations thereof; and
each of said primary and secondary ports comprising an internally threaded socket, each of said plurality of other ports of said manifold being adapted, optionally or alternatively, to be either plugged or connected to a pressure gauge, a transducer, a controller device, a source of dioxygen, or a source of dynamic vacuum.

16. Apparatus as set forth in claim 15 wherein said tubular process vessel comprises a tubular combustion region segment surrounding said combustion station, and a tubular transition glass segment between said combustion region segment and said primary gas port, said transition glass segment being fused at its inward end to said combustion region segment and in gas flow communication at its outward end with said primary gas port, said combustion region segment being constituted of a glass capable of withstanding combustion temperatures in excess of 500° C., said transition glass segment comprising borosilicate glass, and the composition of the glass at the inward end of said transition segment that is fused to said combustion region segment being such that the joint between said combustion region segment and said transition segment remains substantially stable when said combustion region is repetitively cycled between ambient temperature and a temperature of about 500° C.

17. Apparatus as set forth in claim 14 further comprising a second station within said vessel, said second station being spaced from both said first station and said port with respect to the longitudinal axis of said vessel, and a third station spaced from said first station and said second station, said second station being adapted to contain a condenser for water vapor and/or a sorbent for sorbing water vapor or carbon monoxide, and said third station being adapted to contain a supplemental reaction agent.

18. Apparatus as set forth in claim 15 comprising a sealed greaseless connection between said primary gas port and a source of dioxygen and a sealed greaseless connection between said secondary access port and another functional device, each of said connections comprising a threaded bushing, an O-ring and a threaded socket.

19. Apparatus as set forth in claim 14 wherein said tubular process vessel is substantially transparent and substantially corrosion resistant, and may be reused for greater than 50 combustion/sorption cycles.

20. Apparatus as set forth in claim 14 wherein said tubular process vessel and said furnace can comprise a combined assembly capable of wheel mobility.

21. A process for isolating a carbon fraction representative of the carbon contained in a specimen of a condensed phase carbonaceous composition, said fraction being isolated in the form of a carbon oxide gas that may be introduced into a gas analyzer for determining the carbon isotope proportion of said composition that is constituted by C, the process comprising:
contacting a condensed phase specimen of said composition with a primary oxidant in a combustion region within a zone for generation and isolation of a carbon oxide derived from carbon contained in the specimen;
reacting said specimen in said combustion region to generate a combustion product gas comprising carbon oxides and water; and
determining the C-isotope content of a carbon oxide gas fraction or a sample thereof produced in said generation and isolation zone, said carbon oxide gas fraction comprising said combustion product gas or a gas fraction obtained by modifying the composition of the combustion product gas.

22. A process for isolating a carbon fraction representative of the carbon contained in a specimen of a condensed phase carbonaceous composition selected from the group consisting of algal cells, peptides, proteins, protein extracts, starch, nitroanilines, polyaromatic hydrocarbons, starches, polymers, and elemental carbon, said fraction being isolated in the form of a carbon oxide gas that may be introduced into a gas analyzer for determining the carbon isotope proportion of said composition that is constituted by C, the process comprising:
contacting said specimen in a condensed or vaporized state with a primary oxidant in a combustion region within a zone for generation and isolation of a carbon oxide derived from carbon contained in the specimen;
reacting said specimen in said combustion region to generate a combustion product gas comprising carbon oxides and water; and
determining the C-isotope content of a carbon oxide gas fraction or a sample thereof produced in said generation and isolation zone, said carbon oxide gas fraction comprising said combustion product gas or a gas fraction obtained by modifying the composition of the combustion product gas.
